(19) United States
(12) Patent Application Publication
(10) Pub. No.: US 2004/0225476 A1
(43) Pub. Date: Nov. 11, 2004

(54) Inspection apparatus for diagnosis

(76) Inventor: Der Yang Tien, Taipei (TW)

Correspondence Address: Mr. Joseph A. Sawyer, Jr., SAWYER LAW GROUP LLP, Suite 406, 2465 East Bayshore Road, Palo Alto, CA, 94303, US

(21) Appl. No.: 10/767,129

(22) Filed: Jan. 28, 2004

(30) Foreign Application Priority Data
May 8, 2003 (TW) 092112524

(51) Int. Cl. G06F 11/00

(52) U.S. Cl. 702/188; 600/437; 340/539.12

(57) ABSTRACT

An inspection apparatus incorporates at least a stethoscope inspection mode and an ultrasonic wave inspection mode. A signal processing module converts the analog signals received by a conversion module into digital signals, and stores the digital signals in a storage unit. A communicate module transmits the digital signals to a data processing device comprising wireless communicating interface, and thus a user of the data processing device obtains the inspection results displayed on a display unit of the data processing device.

### FIELD OF THE INVENTION

The present invention relates generally to an inspection apparatus for diagnosis, and more particularly, to an inspection apparatus for diagnosis incorporating at least a conversion module comprising stethoscope and ultrasonic wave, and to an inspection apparatus for diagnosis having wireless transmitting and receiving function.

### BACKGROUND OF THE INVENTION

The original stethoscope, so far, has not been improved or changed a lot since invented in the nineteen century. The widely used stethoscope normally comprises: a large conversion module which is placed on the skin of a patient; a small conversion module which is placed in the ear of a user; and a connecting pipe interconnecting the large conversion module and the small conversion module (the connecting pipe may comprise, for example, a metal pipe connecting with the small conversion module, and a flexible pipe connecting with the metal pipe and the large conversion module). The vibration energy of the air in the connecting pipe is not easily leaked out to the outer environment. The vibration energy received by the large conversion module is approximately fully transmitted to the small conversion module for stimulating the user's eardrum. Therefore the user analyzes the patient's physiological condition according to the sound he/she heard.

As aforementioned, the stethoscope enables that the user analyzes the patient's physiological condition according to the sound he/she heard, however, to a user who has insufficient experience, how to analyze the patient's physiological condition according to the sound collected by the stethoscope is a big problem, even if to an experienced user, wrong judgment is still sometimes inevitably made. In addition, to normal users who do not have the professional knowledge in the field of medicine, because they are unable to relate the physiological symptom to the corresponding disease, they can not judge the status of the patient in a dangerous situation, which is usually the main reason for missing the first aid opportunity.

As the medium in which the vibration energy of the sound being transmitted, the connecting pipe is an indispensable component of the stethoscope. However, the physical structure of the connecting pipe limits that the stethoscope can only be used by one user. Although there are one-to-many type stethoscopes provided in the market, the limitation of the user's number and the complicated physical structure of this kind of stethoscope also bring about a lot of inconvenience.

Further, conventional stethoscope does not have a data storage function, so the patient, who is supposed to make a long term inspection to the physiological condition, must take down each inspection result about the physiological condition information after analyzing the sound achieved by the stethoscope. However, said inspection results is rather subjective, other stethoscope users may be unable to draw a conclusion about the patient's physiological condition according to what is taken down. Thus inconvenience and non objectivity is also the problems in the way.

In another aspect, ultrasonic wave inspection device is another important and indispensable tool for a user who performs an inspection about a patient's physiological condition. The ultrasonic wave inspection device can display the image of the physiological condition of the inside of a human body without employing an invading style. Therefore the user can more specifically determine the exact physiological condition according the image. Although the ultrasonic wave inspection device does a great help to the diagnosis, whereas the bulky volume thereof is very inconvenient for the user and the patient in a mobile condition, for instance, a doctor can not bring the ultrasonic wave inspection device with him to another place to perform the inspection for the patient because of the non portable character of the device. Although nowadays there is portable ultrasonic wave inspection device provided in the market, the volume and weight of said portable ultrasonic wave inspection device, which incorporating components like ultrasonic wave conversion module, display monitor, data processing system, battery and so on, still form a heavy burden for the user.

The aforementioned stethoscope and ultrasonic wave inspection device, and other devices and apparatuses, like the body temperature inspection device and pulse inspection device, are all independent inspection devices or apparatuses. Therefore, in the condition that multiple physiological conditions are to be inspected, said independent inspection devices or apparatuses must be taken along with the user. Apparently, inconvenience is not only formed in the course of carrying said independent inspection devices or apparatuses, but also formed in the course of inspection.

Additionally, in the event that highly contagious diseases, for example severe acute respiratory syndrome (SARS), outbreak, patients are isolated in a specific environment, thus the medical staff must enter into said specific environment to perform the inspections. If the medical staff can perform the inspections via an inspection device incorporating graphic user interface and proper operation instructions, a lot of medical costs can be saved and the chance of the medical staff to be infected can be reduced. Furthermore, if normal users can perform the inspections via said inspection device incorporating graphic user interface and proper operation instructions, and the inspection results are transmitted to distant terminal for medical staff performing analyzing through telephone, network communication system or other communication apparatuses, medical costs and the chance of the medical staff to be infected can also be reduced.

Thus, how to integrate said independent inspection devices or apparatuses to form a portable and convenient inspection apparatus for diagnosis has become a problem to be solved.

### SUMMARY OF THE INVENTION

The primary objective of the present invention is to provide an inspection apparatus for diagnosis, wherein signal achieved by the inspection apparatus are transmitted to a user via wireless data transmit mode.

Another objective of the present invention is to provide an inspection apparatus for diagnosis, wherein user can perform digitalized data processing for specifically mastering patient's physiological condition.

A further objective of the present invention is to provide an inspection apparatus for diagnosis, wherein user can store inspection results data for performing researching, analyzing or comparing.

In accordance with the above and other objectives, the present invention proposes an inspection apparatus for diagnosis. The inspection apparatus for diagnosis includes: a micro processing unit which actuates units and/or modules of the inspection apparatus according to a instruction of a user or a program; an input unit adapted to input instruction or data; a conversion module comprising at least a receive unit for receiving sound and a transceiver unit for emitting and receiving ultrasonic wave energy signal; a signal processing module which converts the analog signals received by the conversion module into digital signals; a memory unit adapted to realize high speed data access for the units and/or modules of the inspection apparatus; a communication module which is controlled by the micro processing unit for enabling the inspection apparatus intercommunicating with other data processing devices; and a display unit for displaying the inspection results or processes.

In the operation of the inspection apparatus of the present invention, the micro processing units actuates the composed units and/or modules of the inspection apparatus according to the instruction inputted via the input unit; secondly, if the user is to operate the receive unit of the conversion module, the operation mode is switched to another operation mode wherein the receive unit receives the sound signals; thirdly, the signal processing module converts the analog signals received by the conversion module into digital signals, and temporarily stores the digital signals to the memory unit; fourthly, the micro processing unit further converts the digital signals into characters, static images or dynamic images, and displays said characters, static images or dynamic images on the display unit; last, the micro processing unit stores said characters, static images or dynamic images to the storage unit according to the instruction inputted by the user, and/or the micro processing unit transmits said characters, static images or dynamic images to other data processing device and/or system via the communicate module.

Compared with conventional inspection apparatuses, user can employ the individual inspection apparatus of the present invention to perform at least a stethoscope inspection and an ultrasonic wave inspection, and further obtain inspection results achieved by the inspection apparatus via wireless data transmitting mode. In another aspect, the user can more specifically master the patient's physiological condition, and store the inspection results data via digitalized data process, thereby facilitating the researching, analyzing and comparing to said data.

### BRIEF DESCRIPTION OF THE DRAWINGS

The drawings included herein provide a further understanding of the invention. A brief description of the drawings is as follows:

FIG. 1 is a block schematic diagram of an inspection apparatus for diagnosis in accordance with the present invention, showing the configuration the inspection apparatus;

FIG. 2 is a workflow diagram of the inspection apparatus of FIG. 1, showing the inspection apparatus performing a stethoscope inspection mode;

FIG. 3 is a workflow diagram of the inspection apparatus of FIG. 1, showing the inspection apparatus performing an ultrasonic wave inspection mode; and

FIG. 4 is a workflow diagram of an alternative embodiment of the inspection apparatus, showing the inspection apparatus performing a stethoscope inspection mode via the remote control of a data processing device and/or system.

### DETAILED DESCRIPTION

The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

### FIRST EMBODIMENT

In present invention, an inspection apparatus for diagnosis in accordance with the present invention provides at least stethoscope function and ultrasonic wave signal transceiver function, further comprises an image capturing module for providing user with images which shows a further physiological condition of a patient. However, the present invention is not limited to provide stethoscope function and ultrasonic wave signal transceiver function, but also can incorporate other physiological condition inspection devices, for example infrared body temperature inspection device and/or pulse inspection device, wherein a user can simultaneously or subsequently perform different physiological condition inspections via the single inspection apparatus for diagnosis.

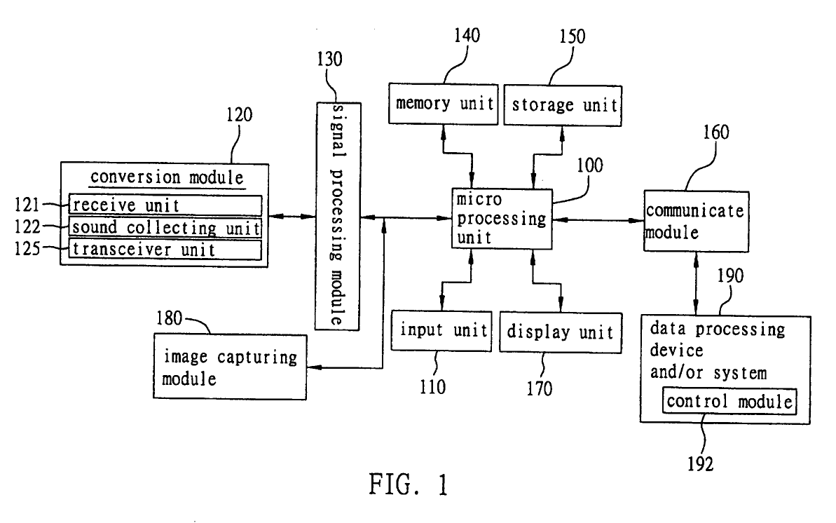

Referring to FIG. 1, a configuration the inspection apparatus of the present invention is shown. The inspection apparatus comprises a micro processing unit 100, an input unit 110, a conversion module 120, a signal processing module 130, a memory unit 140, a storage unit 150, a communicate module 160, a display unit 170, and an image capturing module 180.

The micro processing unit 100 is employed for capturing signal, decoding, implementing instructions, and driving the composed units and/or modules, and further transmitting and receiving data from other resource via data transmit and receive passage, such as bus.

The input unit 100 is employed for inputting instructions or data, thereby driving the composed units and/or modules via the micro processing unit 100. The input units 110 can be one of the keyboard, touch panel, mouse and track ball.

The conversion module 120 comprises at least a receive unit 121 for receiving sound and a transceiver unit 125 for transmitting and receiving ultrasonic wave energy signal. The receive unit 121 is employed to receive sound signal for the conversion module 120. The receive unit 121 comprises at least a sound collecting unit 122 receiving the sound signal. The transceiver unit 125 is employ for emitting an ultrasonic wave energy signal according to the instructions of the micro processing unit 100, and for receiving an echo signal of the ultrasonic wave energy signal for thereby achieving the physiological structure and condition inside a human body. The specific structure and function of the receive unit 121, the sound collecting unit 122, and the transceiver unit 125 are known to those skilled in the art, thereby being omitted herein.

In addition, the conversion module 120, according to practice, further incorporates aforementioned infrared body temperature inspection device and/or pulse inspection device and other physiological condition inspection unit therein, for enhancing the function and convenience of the inspection apparatus of the present invention.

The signal processing module is employed for converting the analog signal received by the conversion module 120 into a corresponding digital signal. As mentioned above, the signals received by the sound collecting unit 122 of the conversion module 120, and the transceiver unit 125 are analog signals, wherein the analog signals are employed in the signal data processing performing by the micro processing unit 100. Thus said analog signals must be converted into digital signals for being employed in the micro processing unit 100. The micro processing unit 100 employs specific software program or hardware module to further convert the digital signals into characters, sounds, static images, dynamic images or other data formats to be displayed or stored for being analyzed, researched and compared.

The memory unit 140 is random access memory (RAM), such as dynamic random access memory (DRAM), synchronous dynamic random access memory (SDRAM), double data rate synchronous dynamic random access memory (DDRSDRAM), or other random access memories, through which other composed modules or units of the inspection apparatus of the present invention realize high speed data access via the micro processing unit 100.

The storage device 150 is employed for storing data, such as pre-installed operation system for the user to operate the inspection apparatus of the present invention and/or application program software used in relating inspection operation; and the digital signals converted by the signal processing module 130 and/or other data inputted by the user. The storage unit 150 is a kind of non-volatile storage media, such as hard disk drive (HDD), compact flash (CF) card, smart media (SM) card, memory stick, secure digital (SD) card, extreme digital (XD) card or other multi media card (MMC).

The communicate module 160 is employed for transmitting data between the inspection apparatus of the present invention and other data processing device and/or system 190. In the present embodiment, the communicate module 160 is a wireless transmitting interface, such as radio frequency (RF) transmitting interface, infrared transmitting interface or blue tooth transmitting interface. The inspection apparatus of the present invention intercommunicates with the data processing device and/or system 190 incorporating corresponding wireless transmitting interface via the communicate module 160. The data processing device and/or system 190 can be one of the personal computer (PC), notebook computer (NB), handheld computer, Personal Digital Assistant (PDA), mobile phone and other wireless receiving and broadcasting units incorporating speaker unit. The sounds, static images or dynamic images achieved by the communicate module 160 are transmitted to the user's data processing device and/or system 190, for the user synchronously performing determining, analyzing, comparing or researching of the patient's physiological conditions. Furthermore, the sounds, static images or dynamic images achieved by the communicate module 160 are transmitted to the user's data processing device and/or system 190; and stored in a storage unit of the data processing device and/or system 190, for the user in performing determining, analyzing, comparing or researching of the patient's physiological conditions later.

The display unit 170 is employed for displaying the inspection results or operation instructions of the inspection apparatus of the present invention. The display unit 170 is controlled by the micro processing unit 100, and displays characters, sounds, static images or dynamic images according to the signal instructions of the micro processing unit 100. In the present embodiment, the display unit 170 is a liquid crystal display (LCD) monitor. In addition, in the present embodiment, to reduce the area and volume of the input unit 100, the display unit 170 alternately is a touch screen, wherein the user can input instructions, data or information by touching the screen.

The image capturing module 180 converts light source signals into digital signals via charge-coupled device (CCD), complementary metal-oxide semiconductor (CMOS) or other electronic sensitization device; and store said digital signals in the memory unit 140 or the storage unit 150.

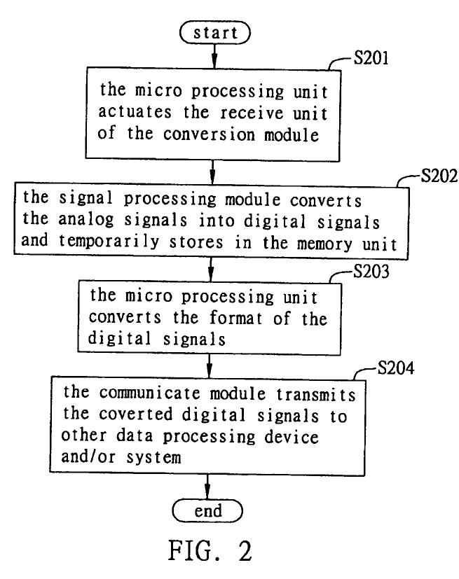

Referring to FIG. 2, a workflow diagram of the inspection apparatus of the present invention performing a stethoscope inspection mode is illustrated.

In step S201, the micro processing unit 100 actuates the receive unit 121 of the conversion module 120 to operate via a “select stethoscope inspection function” instruction inputted by the input unit 1 10 and/or the display unit 170, thereby the inspection apparatus of the present invention performing a stethoscope inspection mode. In the present embodiment, the sound collecting unit 122 of the receive unit 121 is placed on the object portion of where to be inspected, such as heart or lung, in said stethoscope inspection mode. Additionally, in the present embodiment, the image capturing module 180 captures the outside physiological static images or dynamic images of the patient. Step S202 is to be implemented.

In step S202, the signal processing module 130 converts the analog signals received by the receive unit 121 of the conversion module 120 into digital signals and temporarily stores in the memory unit 140. As mentioned above, after that the receive unit 121 of the conversion module 120 receives the sound analog signals of heart beat or breath, the conversion module 120 transmits the sound analog signals to the signal processing module 130. The signal processing module 130 receives and converts the sound analog signals into digital signals; transmits the digital signals to the micro processing unit 100, and temporarily stores in the memory unit 140. Step S203 is to be implemented.

In step S203, the micro processing unit 100 further converts the digital signals converted by the conversion module 130, and static images or dynamic images captured by the image capturing module 180 into characters, static images or dynamic images format information displayed on the screen of the display unit 170. Furthermore, the micro processing unit 100 stores the characters, static images or dynamic images format information in the storage unit 150 according to the instructions inputted via the input unit 1 10 and/or the display unit 170. Step S204 is to be implemented.

In step S204, the micro processing unit 100 transmits the characters, static images or dynamic images format information to the data processing device and/or system 190 via the communicate module 160 according to the instructions inputted via the input unit 1 10 and/or the display unit 170, for the user of the data processing device and/or system 190 synchronously performing analyzing, comparing or researching to the physiological condition information.

In another aspect, the characters, static images or dynamic images format information transmitted to the data processing device and/or system 190 via the communicate module 160 is stored in the storage unit of the data processing device and/or unit 190, for the user of the data processing device and/or system 190 performing analyzing, comparing or researching to the physiological condition information later.

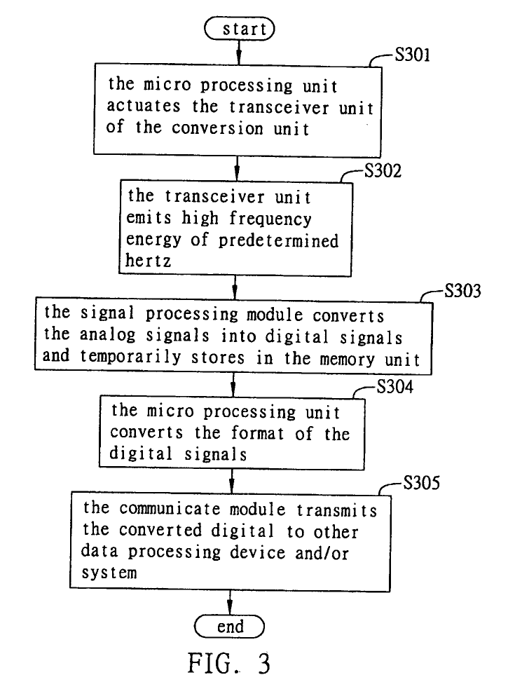

Referring to FIG. 3, a workflow diagram of the inspection apparatus of the present invention performing an ultrasonic wave inspection mode is illustrated.

In step S301, the micro processing unit 100 actuates the transceiver unit 125 of the conversion module 120 to operate via a “select ultrasonic wave inspection function” instruction inputted by the input unit 1 10 and/or the display unit 170, thereby the inspection apparatus of the present invention performing an ultrasonic wave inspection mode. In the present embodiment, the transceiver unit 125 is placed on the object portion of where to be inspected, such as lung or womb, in said ultrasonic wave inspection mode. Additionally, in the present embodiment, the image capturing module 180 captures the outside physiological static images or dynamic images of the patient. Step S302 is to be implemented.

In step S302, the transceiver unit 125 emits high frequency energy of predetermined hertz according to the instructions inputted by the input unit 110 and/or the display unit 170. Step S303 is to be implemented.

In step S303, the signal processing module 130 converts the analog signals received by the transceiver unit 125 of the conversion module 120 into digital signals and temporarily stores in the memory unit 140. As mentioned above, after that the transceiver unit 125 of the conversion module 120 receives the echo sound analog signals, the conversion module 120 transmits the sound analog signals to the signal processing module 130. The signal processing module 130 receives and converts the sound analog signals into digital signals; transmits the digital signals to the micro processing unit 100, and temporarily stores in the memory unit 140. Step S304 is to be implemented.

In step 304, the micro processing unit 100 further converts the digital signals converted by the conversion module 130, and static images or dynamic images captured by the image capturing module 180 into characters, static images or dynamic images format information displayed on the screen of the display unit 170. Furthermore, the micro processing unit 100 stores the characters, static images or dynamic images format information in the storage unit 150 according to the instructions inputted via the input unit 110 and/or the display unit 170. Step S305 is to be implemented.

In step S305, the micro processing unit 100 transmits the characters, static images or dynamic images format information to the data processing device and/or system 190 via the communicate module 160 according to the instructions inputted via the input unit 110 and/or the display unit 170, for the user of the data processing device and/or system 190 synchronously performing analyzing, comparing or researching to the physiological condition information.

In another aspect, the characters, static images or dynamic images format information transmitted to the data processing device and/or system 190 via the communicate module 160 is stored in the storage unit of the data processing device and/or unit 190, for the user of the data processing device and/or system 190 performing analyzing, comparing or researching to the physiological condition information later.

### SECOND EMBODIMENT

In the present embodiment, the data processing device and/or system 190 of the inspection apparatus as the first embodiment further comprise a control module 192. The control module 192 remote controls the inspection apparatus of the present embodiment when the communicate module 160 intercommunicates with the data processing device and/or system 190 via wired or wireless transmitting interface, wherein the control module 192 is a software program or firmware incorporated in the data processing device and/or system 190. The control module 192 provides a more convenient way for controlling the inspection apparatus of the present embodiment. The communicate module 160 receives instructions of the data processing device and/or system 190. The micro processing unit 00 actuates the corresponding units and/or modules of the inspection apparatus of the present embodiment to work.

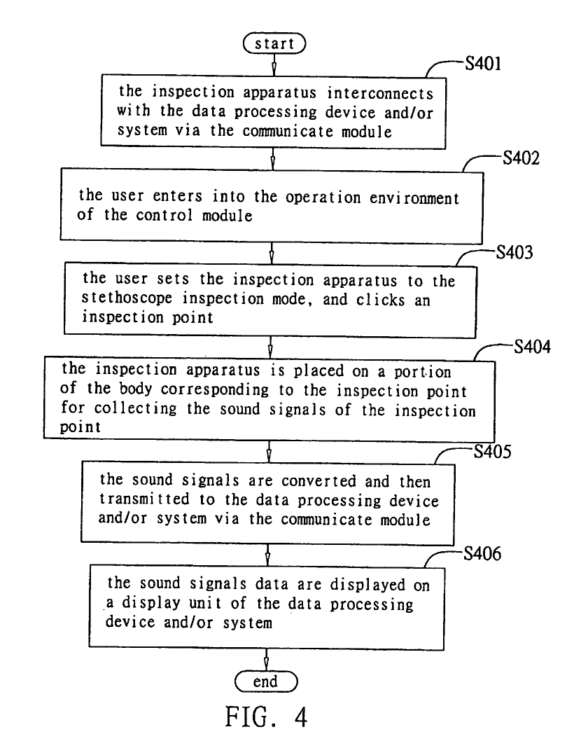

Referring FIG. 4, a workflow diagram of the inspection apparatus of the present embodiment performing a stethoscope inspection mode via the remote control of the data processing device and/or system 190 is illustrated.

In step S401, the communicate module 160 of the inspection apparatus of the present embodiment interconnects with the data processing device and/or system 190. Step S402 is to be implemented.

In step S402, the user enters the operation environment of the control module 192. In the present embodiment, the contents shown in the operation environment include the identification number (health card number) and/or other data showing identification, name, inspection date, gender, age and/or inspection address, wherein patient's the physiological condition information includes body temperature, heart beat frequency, electrocardiogram, sound wave diagram and/or ultrasonic wave diagram, and other data information or diagrams. In addition, the control module 192 can display the images of organs inspected, such as heart, lung (chest or back), or stomach, wherein at least one inspection point is marked on said images. The corresponding component of the inspection apparatus of the present embodiment is placed on an inspection portion corresponding to the inspection point for performing process like collecting sound. The sound signals data is stored in the storage unit of the data processing device and/or system 190 via the communicate module 160. Thus the user can achieve history inspection data information by clicking the corresponding inspection point. Step S403 is to be implemented.

In step S403, the user sets the inspection apparatus of the present embodiment to the stethoscope inspection mode, and click an inspection point “A” disposed in the left lung of the chest of the patient. Step 404 is to be implemented.

In step S404, the sound collecting unit 122 is placed on a portion of the patient corresponding to the inspection point 37 A”, for collecting the sound signals of the inspection point “A”. Step S405 is to be implemented.

In step 405, the inspection apparatus of the present embodiment converts and then transmits the sound signals to the data processing device and/or system 190 via the communicate module 160. Step S406 is to be implemented.

In step S406, the signal data is displayed on a display unit of the data processing device and/or system 190, and stored in a storage unit of the data processing device and/or system 190 according to the user's requirement for performing researching, analyzing or comparing to the signal data later.

Conclusively, the user can employ the inspection apparatus of the present invention to perform inspection operations at least including stethoscope inspection and ultrasonic wave inspection; in addition, the user can obtain the physiological condition signals achieved by the inspection apparatus of the present invention via wireless data transmitting mode. In another aspect, the user can more specifically master the patient's physiological condition, and store the inspection results data via digitalized data process, thereby facilitating the researching, analyzing and comparing to said data.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. An inspection apparatus for diagnosis, comprising:
a micro processing unit for actuating units and modules of the inspection apparatus via an instruction of a user or a program;
an input unit for allowing the user to input the instruction or data;
a conversion module comprising at least a receive unit for receiving sound and a transceiver unit for emitting and receiving ultrasonic wave energy signals;
a signal processing module for converting analog signals received by the conversion module into digital signals;
a memory unit for allowing high-speed data access for the units and modules of the inspection apparatus;
a storage unit for storing data processed by the micro processing unit according to the instruction inputted via the input unit; and
a communicate module controlled by the micro processing unit, for allowing data communication between the inspection apparatus and at least one data processing device connected to the inspection apparatus.

2. The inspection apparatus as claimed in claim 1, wherein the input unit is one selected from the group consisting of a keyboard, touch panel, mouse, and track ball.

3. The inspection apparatus as claimed in claim 1, wherein the conversion module further comprises an infrared body temperature inspection unit.

4. The inspection apparatus as claimed in claim 1, wherein the conversion module further comprises a pulse inspection unit.

5. The inspection apparatus as claimed in claim 1, wherein the memory unit is one selected from the group consisting of a dynamic random access memory (DRAM), synchronous dynamic random access memory (SDRAM), and double data rate synchronous dynamic random access memory (DDRSDRAM).

6. The inspection apparatus as claimed in claim 1, wherein the storage unit is one selected from the group consisting of a hard disk drive (HDD), compact flash (CF) card, smart media (SM) card, memory stick, secure digital (SD) card, and extreme digital (XD) card.

7. The inspection apparatus as claimed in claim 1, wherein the communicate module comprises a wireless transmitting interface.

8. The inspection apparatus as claimed in claim 7, wherein the wireless transmitting interface is one selected from the group consisting of a radio frequency (RF) transmitting interface, infrared transmitting interface, and blue tooth transmitting interface.

9. The inspection apparatus as claimed in claim 1, further comprising a display unit controlled by the micro processing unit, for displaying inspection results or processes from the inspection apparatus.

10. The inspection apparatus as claimed in claim 9, wherein the display unit is a liquid crystal display (LCD) monitor.

11. The inspection apparatus as claimed in claim 10, wherein the monitor is a touch screen.

12. The inspection apparatus as claimed in claim 1, wherein the data processing device comprises a control module connected with the communicate module of the inspection apparatus via a wired or wireless transmitting interface to control operation of the inspection apparatus.

13. The inspection apparatus as claimed in claim 12, wherein the control module is a software program or firmware incorporated in the data processing device.

14. The inspection apparatus as claimed in claim 12, wherein the data processing device further comprises a display unit for displaying inspection results from the inspection apparatus.
